(19) United States
(12) Patent Application Publication
(10) Pub. No.: US 2021/0295351 A1
(43) Pub. Date: Sep. 23, 2021

(54) AUTOMATED CONSTRUCTION OF COMPLIANT CLOUD ENVIRONMENTS

(71) Applicant: SHUJINKO INC., Seattle, WA (US)

(72) Inventors: MATTHEW WELLS, Preston, WA (US); SCOTT SCHWAN, Seattle, WA (US); JEFFREY ROBERTS, Hayward, CA (US)

(73) Assignee: SHUJINKO INC., Seattle, WA (US)

(21) Appl. No.: 17/064,381

(22) Filed: Oct. 6, 2020

Related U.S. Application Data
(60) Provisional application No. 62/993,657, filed on Mar. 23, 2020.

(51) Int. Cl. G06Q 30/00; G06Q 10/06; G06F 16/23; H04L 29/08

(52) U.S. Cl. CPC G06Q 30/0185; G06Q 10/06315; G06Q 10/20; G06F 16/2379; H04L 67/10; G06Q 10/067

(57) ABSTRACT

Techniques are provided for automated construction of compliant cloud environments. A first standard is processed to generate a first plurality of controls. Construction instructions are generated for automatically creating generated environments at a cloud service provider system that satisfy the first plurality of controls. A request to create a cloud environment for a first customer is received. The construction instructions are executed to provision a first generated environment at the cloud service provider system that is compliant with the first standard. Control of the first generated environment is provided to the first customer.

### CROSS-REFERENCE TO RELATED APPLICATIONS; BENEFIT CLAIM

This application claims the benefit of Provisional Application Ser. No. 62/993,657, filed Mar. 23, 2020, the entire contents of which are hereby incorporated by reference as if fully set forth herein, under 35 U.S.C. § 119(e). This application is also related to copending U.S. patent application Ser. No. ______ (Attorney Docket No. SJK-0012-US1), filed concurrently herewith in the name of inventors Matt Wells, Scott Schwan, and Jeff Roberts, entitled “AUTOMATED EVIDENCE COLLECTION,” the entire contents of which are hereby incorporated by reference as if fully set forth herein.

### FIELD OF THE DISCLOSURE

The present disclosure generally relates to cloud computing, and relates more specifically to constructing cloud environments that comply with one or more standards.

### BACKGROUND

There are many reasons that an organization may implement a standard. For example, an organization may engage in business in a regulated industry that requires a particular standard to be met. An organization may also implement a standard that describes best practices for various reasons, such as to mitigate the risk of a data breach or another potentially costly failure. In some cases, a vendor's customers may prefer or require verification that the vendor satisfies a particular standard. An audit is a process that is performed to evaluate an entity's compliance with a standard.

Compliance and auditing may involve highly complex, time-consuming, and costly processes, especially when a larger organization implements a complex standard. For example, the organization may need to assess its operation, identify necessary changes, and implement the changes in areas such as technology, infrastructure, operations, employment, practices, policies, procedures, and the like. An organization may also need to ensure that compliance with the standard is achieved and maintained. Furthermore, a standard may be updated periodically. When a standard is updated, the organization must become aware of changes to the standard and take action to implement the changes. Auditing may be performed to ensure that an organization complies with a standard.

The approaches described in this section are approaches that could be pursued, but are not necessarily approaches that have been previously conceived or pursued. Therefore, unless otherwise indicated, it should not be assumed that any of the approaches described in this section qualify as prior art merely by virtue of their inclusion in this section.

### SUMMARY

The appended claims may serve as a summary of the invention.

### BRIEF DESCRIPTION OF THE DRAWINGS

In the drawings:

FIG. 1 illustrates a computer system for automated construction of compliant cloud environments in an example embodiment;

FIG. 2 illustrates instructions in a data model for automated construction of compliant cloud environments in an example embodiment;

FIG. 3 illustrates relationships between standard objects, control objects, and evidence objects in a system for automated construction of compliant cloud environments in an example embodiment;

FIG. 4 is a flow diagram of a process for automated construction of compliant cloud environments in an example embodiment;

FIG. 5 illustrates a computer system upon which an embodiment may be implemented.

While each of the drawing figures illustrates a particular embodiment for purposes of illustrating a clear example, other embodiments may omit, add to, reorder, or modify any of the elements shown in the drawing figures. For purposes of illustrating clear examples, one or more figures may be described with reference to one or more other figures, but using the particular arrangement illustrated in the one or more other figures is not required in other embodiments.

### DETAILED DESCRIPTION

In the following description, for the purpose of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

It will be further understood that: the term “or” may be inclusive or exclusive unless expressly stated otherwise; the term “set” may comprise zero, one, or two or more elements; the terms “first”, “second”, “certain”, and “particular” are used as naming conventions to distinguish elements from each other, and do not imply an ordering, timing, or any other characteristic of the referenced items unless otherwise specified; the term “and/or” as used herein encompasses any and all possible combinations of one or more of the associated listed items; that the terms “comprises” and/or “comprising” specify the presence of stated features, but do not preclude the presence or addition of one or more other features.

A “computer” may include one or more physical computers, virtual computers, and/or computing devices. For example, a computer may be, or may comprise, one or more server computers, cloud-based computers, cloud-based cluster of computers, virtual machine instances or virtual machine computing elements such as virtual processors, storage and memory, data centers, storage devices, desktop computers, laptop computers, mobile devices, and/or any other special-purpose computing devices. Any reference to “a computer” herein may mean one or more computers, unless expressly stated otherwise.

A “system” (such as but not limited to compliance server system 110, customer computer system 140, and cloud service provide system 120) may include one or more computers, such as physical computers, virtual computers, and/or computing devices. For example, a system may be, or may comprise, one or more server computers, cloud-based computers, cloud-based cluster of computers, virtual machine instances and/or virtual machine computing elements such as virtual processors, storage and memory, data centers, storage devices, desktop computers, laptop computers, mobile devices, and/or any other special-purpose computing devices. A system may include another system, and computers may belong to two or more systems.

A “module” may be one or more ‘hardware components and/or software stored in, or coupled to, a memory and/or one or more processors on one or more computers. Additionally and/or alternatively, a module may comprise specialized circuitry. For example, a module, such as but not limited to standard processing module 102, construction module 104, and evidence collection module 106, may be hardwired or persistently programmed to support a set of instructions to, and/or that are useful to, perform the functions discussed herein.

As used herein, the term “database” refers to one or more data stores for at least one set of data. The data store may include one or more tangible and/or virtual data storage locations, which may or may not be physically co-located. A simple example of a database is a text file used to store information about a set of data. Another example of a database is one or more data stores that are maintained by a server. Clients may access the database by submitting requests to the server that cause the database server to perform operations on the database. In some embodiments, the server is a server in a database management system (DBMS).

A “server” may include a combination of integrated software components and an allocation of computational resources, such as memory, a computing device, and/or processes on the computing device for executing the integrated software components. The combination of the software and computational resources are dedicated to providing a particular type of function on behalf of clients of the server. A server may refer to either the combination of components on one or more computing devices, or the one or more computing devices (also referred to as “server system”). A server system may include multiple servers; that is, a server system may include a first server and a second server, which may provide the same or different functionality to the same or different set of clients.

A “client” may include a combination of integrated software components and an allocation of computational resources, such as memory, a computing device, and/or processes on a computing device for executing the integrated software components. The combination of the software and computational resources are configured to interact with one or more servers over a network, such as the Internet. A client may refer to either the combination of components on one or more computers, or the one or more computers (also referred to as “client computing devices”).

### General Overview

This document generally describes systems, methods, devices, and other techniques for automated construction of compliant cloud environments. In general, a compliance server system may automate the creation of cloud environments that are compliant with one or more standards. For example, a customer may request creation of a cloud environment that is compliant with a standard, such as Service Organization Control 2 (SOC 2). SOC 2 includes criteria for organizational controls related to security, and optionally availability, processing integrity, confidentiality, and/or privacy. In some embodiments, a standard is processed to generate controls associated with the standard, and construction instructions are generated for automatically creating generated environments that satisfy the plurality of controls. The compliance server system may execute the construction instructions to create a generated environment for the customer that is compliant with the standard.

A customer may also request an audit of a cloud environment to ensure compliance with one or more standards. In some embodiments, collection instructions are generated for collecting evidence data associated with a set of controls associated with a selected standard. The compliance server system may execute the collection instructions to verify whether an environment is in compliance with the selected standard. For example, the compliance server system may execute the collection instructions during a formal or informal audit.

In some implementations, the various techniques described herein may achieve one or more of the following advantages: an organization may implement one or more standards in a cloud architecture with greatly reduced time, effort, and other overhead; an organization may ensure compliance with one or more standards with greatly reduced time, effort, and other overhead; an audit of an organization may be performed with greatly reduced time, effort, and other overhead; an organization may efficiently scale compliance management across one or more cloud environments; and/or a compliance provider operating a compliance server system may streamline deployment, maintenance, and updating of cloud environments. Additional features and advantages are apparent from the specification and the drawings.

### System Overview

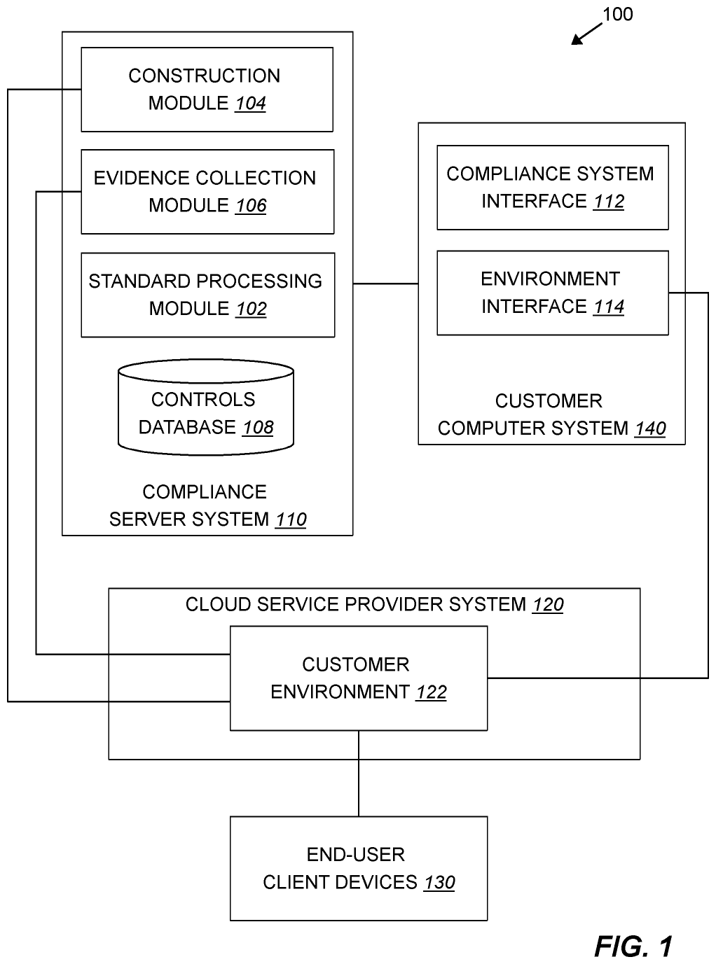

FIG. 1 illustrates a computer system for automated construction of compliant cloud environments in an example embodiment. The computer system 100 includes a compliance server system 110, a customer computer system 140, a cloud service provider system 120, and one or more end-user client devices 130. The compliance server system 110, customer computer system 140, cloud service provider system 120, and end-user client device/s 130 communicate over one or more networks. The network/s may include one or more local area networks (LANs) and/or one or more wide area networks, such as the Internet.

The compliance server system 110 constructs compliant cloud environments at one or more cloud service provider systems 120 for one or more customers. A compliant cloud environment is configured to satisfy one or more standards. For example, the compliance server system 110 may create a customer environment 122 in a cloud service provider system 120 for a particular customer that owns and/or controls a customer computer system 140. While one customer computer system 140, one customer environment 122, and one cloud service provider system 120 are shown, the compliance server system 110 may provide services relating to environments for one or more customer server systems 140; the compliance server system 110 may create customer environments 122 on one or more cloud service provider systems 120; and/or the compliance server system 110 may create one or more customer environments 122.

In some embodiments, the compliance server system 110 includes a standard processing module 102. The standard processing module 102 processes a standard to generate control data that describes one or more aspects of the standard. A control is associated with a standard, and may relate to a particular rule within the standard. The compliance server system 110 may store control data describing one or more standards in a controls database 108. The compliance server system 110 uses the control data to construct compliant cloud environments such as the customer environment 122. In some embodiments, the compliance server system 110 uses the control data to perform an audit of cloud environments (e.g. customer environment 122).

In some embodiments, the compliance server system 110 includes a construction module 104. As used herein, the term “generated environment” refers to an environment created by the compliance server system 110, including environments configured by and/or deployed by the compliance server system 110. The construction module 104 executes construction instructions to create one or more generated environments that are compliant with one or more standards. For example, the construction module 104 may create the customer environment 122 at the cloud service provider system 120 on behalf of the customer that owns and/or manages the customer computer system 140. The customer computer system 140 has access to the customer environment 122. For example, the customer computer system 140 may manage deployment of the customer environment 122 as a live production environment that makes a service and/or application available to end-user client devices 130.

The compliance server system 110 may optionally be configured to perform an audit of the customer environment 122 to check for compliance with one or more standards. In some embodiments, the compliance server system 110 includes an evidence collection module 106. The evidence collection module 106 executes collection instructions to collect evidence data that shows whether one or more environments comply with one or more standards. For example, the evidence collection module 106 may collect evidence data from the customer environment 122 to determine whether the customer environment 122 complies with one or more aspect/s of a standard that are described by the control data.

In some embodiments, the customer computer system 140 communicates with the compliance server system 110. For example, the customer computer system 140 may interact with the compliance server system 110 to request the configuration and/or creation of a customer environment 122 that is compliant with one or multiple standards. Alternatively and/or in addition, the customer computer system 140 may interact with the compliance server system 110 to initiate an audit of the customer environment 122 for compliance with one or multiple standards. Alternatively and/or in addition, the customer computer system 140 may interact with the compliance server system 110 to access compliance data that describes the compliance of the customer environment 122 with one or multiple standards.

The compliance server system 110 and/or its components (e.g. standard processing module 102, construction module 104, evidence collection module 106, and/or controls database 108) as described herein are presented as individual components for ease of explanation; any action involving (e.g. performed by or to) one or more components of the compliance server system 110 may be considered performed with respect to (e.g. performed by or to) the compliance server system 110. The compliance server system 110 and/or its components may be implemented as one or more dependent or independent processes, and may be implemented on one or multiple computers; for example, a component may be implemented as a distributed system. Alternatively and/or in addition, multiple instances of the compliance server system 110 and/or one or more components thereof may be implemented. Furthermore, a component shown may be implemented fully and/or partially in one or more programs or processes, and two or more components shown may be implemented fully and/or partially in one program and/or process.

### Standards

The compliance server system 110 may implement one or more standards, such as SOC 2, Health Insurance Portability and Accountability Act (HIPPA), General Data Protection Regulation (GDPR), Payment Card Industry Data Security Standard (PCI DSS), Federal Information Security Management Act (FISMA), and/or other standards. As used herein, the term “standard” refers to a set of requirements, obligations, criteria, recommendations, guideline, procedures, and the like, referred to hereinafter as “a set of one or more rules.” A standard may be published by a government organization, such as in a law or regulation. A standard may also be published by an organization, such as an industry organization, customer organization, or another body. A standard may also be described by one or more private parties. For example, a customer may define a particular set of rules to implement within its organization. As another example, the terms of a contract or other agreement may include a set of rules that one party wishes to implement.

A standard may include rules on various topics, such as performing background checks, implementing or testing a disaster recovery policy, requiring passwords on computer systems, software updates and patches, handling sensitive data and/or personally identifiable information (PII), security and privacy documentation, preventing unauthorized access, system availability, system redundancy, documentation of incidents, computer system configurations including software, hardware, and/or network configuration, and other rules.

### Controls

The standard processing module 102 may process one or more standards to generate control data that describes a plurality of controls. As used herein, the term “control” refers to an actionable item that the compliance server system 110 can implement in order to comply with a standard. A control is associated with a standard, and may relate to a particular rule within the standard. For example, if a standard includes a control comprising a versioning rule that requires software packages to be updated, the standard processing module 102 may generate control data that describes the versioning rule. In this case, one control may correspond to multiple software packages, or multiple controls may each correspond to an individual software package.

The standard processing module 102 processes a standard to generate control data that describes one or more aspects of the standard. The control data may include construction instructions for creating a generated environment that complies with a standard, and/or collection instructions for verifying whether an environment complies with a standard. Construction instructions and collection instructions are described in greater detail hereinafter.

The standard processing module 102 may store control data describing a set of one or more controls in the controls database 108 to make the control data available to other components of the compliance server system 110, such as the construction module 104 and the evidence collection module 106. In some embodiments, the standard processing module 102 processes one or more standards in accordance with a data model. The data model may include construction instructions and/or collection instructions for one or more controls. Example data models are described in greater detail hereinafter.

In some embodiments, the standard processing module 102 may generate control data corresponding to one or more controls by processing a standard with input from an administrative user. For example, the administrative user may generate the control data for a standard by data entry and/or programmatic methods. In some embodiments, the administrative user uses a standard processing interface of the standard processing module 102 to process the standard and generate the control data. In some embodiments, the standard processing module 102 may automatically process at least a portion of a standard to identify one or more controls of the standard. For example, the standard may be processed in a plain-text form, an eXtensible Markup Language (XML) form, another markup language form, or another digital form. In some embodiments, after automatically identifying a control, the standard processing module 102 presents the control to an administrative user in a standard processing interface for confirmation and/or additional configuration.

In some embodiments, the standard processing module 102 generates control data that is specific to a particular cloud service provider system 120. For example, the compliance server system 110 may generate control data to implement controls related to one or more Amazon Web Services (AWS) features, such as but not limited to:
API Gateway—AWS service for managing REST and Web Socket APIs at scale
Aurora Relational Database Service (RDS) AWS relational database compatible with My SQL and InnoDB storage engine
Bastion Host—Hardened host that sits behind the VPN and acts as an SSH proxy for services within your VPC
Certificate Manager (ACM) AWS certificate service for provisioning, managing, and deploying public and private SSL/TLS certificates
CIS Hardening for AWS Accounts—Automatically apply CIS Benchmark recommended settings to your AWS account
CloudFront—AWS content delivery network service that helps increase your edge presence globally
DynamoDB NoSQL Service—AWS proprietary NoSQL database for key-value and document data structures
EC2 Instance DataDog Integration—Installs the DataDog Agent on EC2 instances
EC2 Instance Falco Integration—Installs the Falco agent on EC2 instances
EC2 Instance Splunk Integration—Installs a fluentd log shipper for integrating with Splunk on EC2 instances
EC2 Instance Wazuh Integration—Installs the Wazuh agent on EC2 instances
EC2 Load Balancer Service—Distribute incoming application traffic across multiple targets within your AWS environment
Elastic Container Registry—AWS Docker container registry
Elastic Container Service (ECS) AWS container orchestration service for Docker containers
Elasticache Memcached—AWS in-memory data store and cache service for Memcached
Elasticache Redis—AWS in-memory data store and cache service for Redis
ElasticSearchAWS ElasticSearch service
InspectorAWS automated security assessment scanner for evaluating application exposure, vulnerabilities, and deviations from best practices on AWS
Key Management Service—AWS managed encryption key service
Lambda—AWS event driven, serverless computing platform
Managed Message Broker (ActiveMQ) Amazon MQ is a managed message broker service for Apache ActiveMQ
OpenVPN—Create a secure point to point connection to your VPC
Route 53 DNS Service—AWS scalable and highly available Domain Name Service
Secrets Manager—AWS service that helps enable rotation, management, and retrieval of secrets throughout their lifecycle
Simple Email Service (SES) AWS email sending service
Simple Notification Service (SNS) AWS solution for mass delivery of messages
Simple Queue Service (SQS) AWS distributed message queueing service
Simple Storage Service (S3) AWS scalable object storage solution
Systems Manager (SSM) Parameter Store—AWS secrets management and configuration data management service
Systems Manager (SSM) Session Manager—AWS service for creating shell-level access within EC2 instances using a secure interface without SSH
Transfer Server (SFTP) AWS SFTP service using S3 as the backend
Virtual Private Cloud—Provision a logically isolated section of the AWS Cloud where you can launch AWS resources in a virtual network that you define
Web Application Firewall—AWS web application firewall service that helps protect web applications from common web exploits

The compliance server system 110 may generate control data to implement controls related to one features provided by Amazon Web Services (AWS), Microsoft Azure, Google Cloud Platform (GCP), other public cloud operating systems, native and third party software services usable in one or more cloud environments, and/or any other similar software related to a customer environment 122.

### Evidence

As used herein, the term “evidence type” refers to a data type that is required to verify whether an associated control is satisfied. The term “evidence data” is used to refer to data of a particular evidence type that is usable to verify whether an associated control is satisfied.

Evidence data may be collected from one or more cloud environments. In some embodiments, the evidence collection module 106 communicates with the cloud service provider system 120 and/or the customer computer system 140 to collect evidence data corresponding to a control. The evidence collection module 106 uses the collected evidence data to verify whether the corresponding control is satisfied.

For example, the evidence collection module 106 may execute collection instructions associated with the control to make an Application Programming Interface (API) call to a customer environment 122 to collect the corresponding evidence data from the customer environment 122. An API is an interface that provides functions/methods of a first software module to a second software module. For example, a web API provided by the cloud service provider system 120 may define Hypertext Transfer Protocol (HTTP) request messages that may be submitted to interact with the customer environment 122. The web API may further define corresponding HTTP response messages that a user of the web API can expect in response to HTTP request messages.

### Environments

As used herein, the term “environment” refers to a set of resources, including but not limited to virtualized resources, that are necessary to execute an application and/or service. For example, in a cloud platform managed by a cloud service provider, an environment may include the set of resources necessary to execute the application and/or service within the cloud platform. A cloud service provider may provide other parties a cloud-based platform that supports the deployment of cloud environments, such as but not limited to virtual machines, containers, and the like.

An environment may refer to one instance or multiple instances of a virtual machine, container, etc. with an identical purpose and/or configuration, referred to herein as duplicate instances. When an environment includes multiple duplicate instances, the compliance server system 110 may perform one or more actions described herein on each duplicate instance to ensure that the individual instances and the collection of duplicate instances are all compliant with one or more standards.

In some embodiments, the compliance server system 110 is configured to generate environments that comply with one particular standard. The construction module 104 may create a generated environment that complies with the particular standard implemented by the compliance server system 110 by obtaining and executing construction instructions in the controls database 108.

The compliance server system 110 may also be configured to generate environments that comply with one or more standards that are selected from a plurality of standards. For example, controls database 108 may include control data for a plurality of controls associated with a plurality of standards. The construction module 104 may create a generated environment that complies with a selected standard by obtaining and executing construction instructions associated with controls that are associated with the selected standard from the controls database 108. The construction module 104 may create a generated environment that complies with two or more selected standards by selecting a set of controls associated with any of the two or more selected standards from the controls database 108, and execute construction instructions associated with the selected set of controls. The evidence collection module 106 may audit a customer environment 122 for compliance with two or more selected standards in a similar manner.

In some embodiments, when two selected standards each have a rule on the same topic, the construction module 104 and/or evidence collection module 106 may resolve the two similar rules, such as by applying the more restrictive rule of the two rules. For example, if a first rule requires a weekly update and a second rule requires a daily update of the same item, the compliance server system 110 may resolve the two rules by using the second rule.

In some embodiments, a compliance server system 110 adapts an existing cloud environment of a customer that is not provisioned by the construction module 104 to allow the evidence collection module 106 to audit the existing cloud environment system.

### Construction Instructions

When the compliance server system 110 creates a customer environment 122, the construction module 104 may provision and/or otherwise configure the customer environment 122 such that the customer environment 122 complies with one or more standards. In some embodiments, the standard processing module 102 generates construction instructions for automatically creating generated environments that satisfy one or more controls associated with a standard. The construction module 104 may execute the construction instructions associated with the controls to create generated environments that are compliant with the standard.

The construction instructions may include one or more parameters, arguments, pointers, references, executable code, calls, or other instructions that are usable by the construction module 104 to create a generated environment that is compliant with a control and/or standard. When the construction module 104 executes the construction instructions, the construction module 104 executes code that is included in or generated based on the relevant construction instructions.

For example, when the construction instructions for a control includes an API call, the construction module 104 may execute the construction instructions by making the API call. As another example, when the construction instructions include executable code, the construction module 104 may execute the construction instructions by executing the executable code in the construction instructions. As another example, when the construction instructions include an argument to a function or call, the construction module 104 may execute the construction instructions by executing the corresponding function or call with the argument. As another example, when the construction instructions include a parameter, the construction module 104 may execute the construction instructions by creating or modifying one or more configuration files, other configuration data, executable code, or other data based on the parameter and execute executable code that uses the data.

In some embodiments, the compliance server system 110 is configured to provision generated environments at one or more cloud service provider systems 120. The compliance server system 110 may have different construction instructions for the different cloud service provider systems 120.

In some embodiments, the compliance server system 110 receives a request to create, at the cloud service provider system 120, a cloud environment for a customer that is compliant with a first standard. In response to the request, the construction module 104 executes constructions instructions associated with the first standard to provision a customer environment 122 such that the customer environment 122 is compliant with the first standard. The compliance server system 110 provides control of the customer environment 122 to the customer.

In some embodiments the compliance server system 110 processes a plurality of standards to generate a plurality of controls. The compliance server system 110 may receive a request to create, at the cloud service provider system 120, a cloud environment for a customer that is compliant with one or more selected standards selected from the plurality of standards processed by the compliance server system 110. In response to the request, the construction module 104 selects a relevant set of controls associated with the selected standard/s from the plurality of controls, and selects a set of relevant construction instructions associated with the relevant set of controls. The compliance server system 110 executes the relevant set of construction instructions associated with the selected standard/s to provision a customer environment 122 such that the customer environment 122 is compliant with the selected standard/s. The compliance server system 110 provides control of the customer environment 122 to the customer.

In some embodiments, the construction module 104 generates a dependency graph of construction instructions to be executed to provision a customer environment 122. For example, the dependency graph may be based on a data model (e.g. data model 200), and may include standard-specific construction instructions (e.g. standard-specific construction instructions 210), control-specific construction instructions (e.g. control-specific construction instructions 210), and/or evidence-specific construction instructions (e.g. evidence-specific construction instructions 214), which are described in greater detail hereinafter. The construction module 104 uses the dependency graph to determine an order of execution of the construction instructions.

The construction module 104 may create the customer environment 122 by directly communicating with the cloud service provider system 120 to create the customer environment 122. Alternatively and/or in addition, the construction module 104 may create the customer environment 122 by interacting with the customer computer system 140 to cause the customer computer system 140 to communicate with the cloud service provider system 120 to create the customer environment 122. For example, the construction module 104 may provide a compliance system interface 112 to the customer computer system 140 that causes the customer computer system 140 to communicate with the cloud service provider system 120 to create the customer environment 122. In some embodiments, the customer computer system 140 manages the customer environment 122 using an environment interface 114 provided by the compliance server system 110 and/or the cloud service provider system 122.

### Collection Instructions

When the compliance server system 110 audits a customer environment 122 for compliance with a standard, the evidence collection module 106 interacts with the customer computer system 140 or the cloud service provider system 120 to collect evidence data associated with a set of controls associated with the standard. In some embodiments, the evidence collection module 106 obtains the associated collection instructions that were generated by the standard processing module 102, which may be stored in the controls database 108. The evidence collection module 106 may execute the collection instructions associated with the set of controls to obtain evidence data usable to verify whether one or more customer environments 122 are compliant with the standard. Because the construction instructions associated with a standard are configured to cause provisioning of a customer environment 122 that is compliant with the corresponding standard, evidence data collected by the construction instructions are expected to be compliant with the standard at the time that the customer environment 122 is provisioned.

The collection instructions may include one or more parameters, arguments, pointers, references, executable code, calls, or other instructions that are usable by the evidence collection module 106 to collect the associated evidence data. When the evidence collection module 106 executes the collection instructions, the evidence collection module 106 executes code that is included in or generated based on the relevant collection instructions.

For example, when the collection instructions for a control includes an API call, the evidence collection module 106 may execute the collection instructions by making the API call to collect evidence data. As another example, when the collection instructions include executable code, the evidence collection module 106 may execute the collection instructions by executing the executable code in the collection instructions to collect evidence data. As another example, when the collection instructions include an argument to a function or call, the evidence collection module 106 may execute the collection instructions by generating instructions including the function or call with the specified argument and executing the generated instructions to collect evidence data. As another example, when the collection instructions include a parameter, the evidence collection module 106 may execute the collection instructions by creating or modifying one or more configuration files, other configuration data, executable code, or other data based on the parameter and execute executable code that uses the data to collect evidence data.

The evidence collection module 106 may perform an audit of a customer that controls one or more customer environments 122. When the evidence collection module 106 audits the customer, the evidence collection module 106 may directly communicate with the customer environment/s 122 at the cloud service provider system 120. Alternatively and/or in addition, the evidence collection module 106 may audit the customer by interacting with the customer computer system 140 to cause the customer computer system 140 to communicate with the customer environment/s 122 at the cloud service provider system 120. For example, the evidence collection module 106 may provide a compliance system interface 112 to the customer computer system 140 that causes the customer computer system 140 to communicate with the customer environment 122 at cloud service provider system 120 to obtain evidence data.

### Example Data Model

In some embodiments, the standard processing module 102 processes one or more standards in accordance with a data model. The data model may include construction instructions and/or collection instructions for one or more controls. Example data models are described herein without limiting the organization of control data or other standard-related data to a particular example.

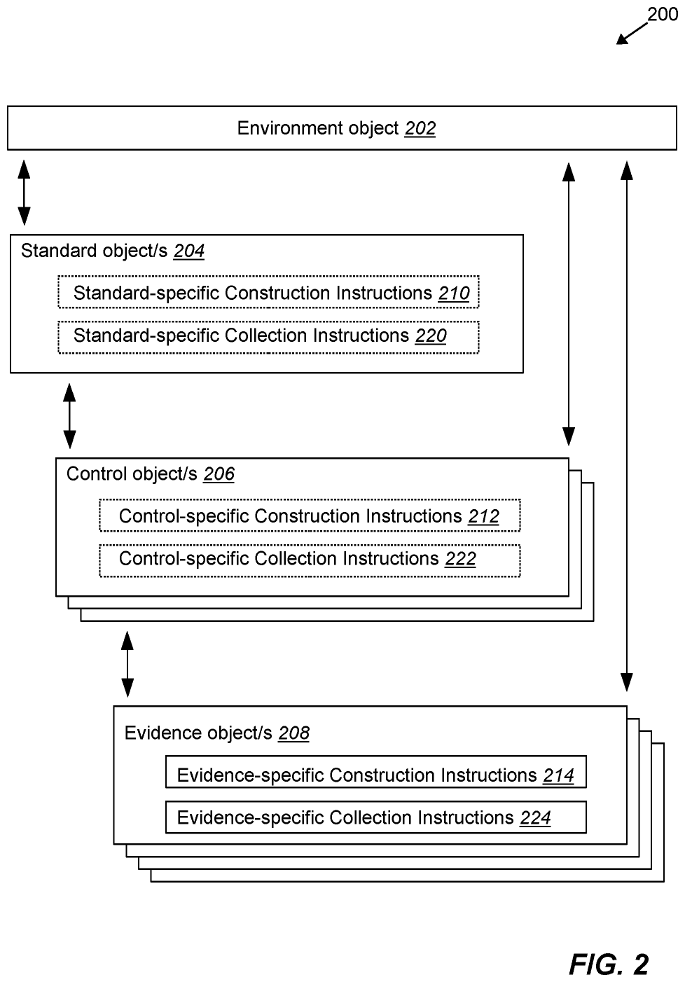

FIG. 2 illustrates instructions in a data model for automated construction of compliant cloud environments in an example embodiment. As used herein, an object refers to any data structure that represents the indicated concept. A data model may be implemented in one or more embodiments that includes or omits one or more of the object types shown in the example data model 200.

In some embodiments, the data model 200 includes an environment object 202. An environment object 202 corresponds an environment (e.g. customer environment 122). When an environment is configured to comply with one or more standards, the corresponding environment object 202 is associated with one or more standard objects 204 that represent the one or more standards.

When a standard is associated with a set of one or more controls, the corresponding standard object 204 is associated with one or more control objects 206 that represent controls in the set of one or more controls. As used herein, with respect to objects, the term “associated with” refers to a relationship that is represented in at least one of the data objects involved. For example, a standard object 204 may include relationship data identifying one or more control objects 206, and/or vice versa.

A control may be associated with one or more evidence types that are required to verify whether an associated control is satisfied. One control may require one or multiple evidence to verify whether the control is satisfied. When a control is associated with one or more evidence types, the corresponding control object 206 is associated with one or more evidence objects 208 that represent the required evidence type/s.

In some embodiments, a one-to-one relationship, one-to-many relationship, or many-to-many relationship may exist between environment objects 202 and standard objects 204. That is, a particular environment object 202 may be associated with one or multiple standard objects 204, and/or a particular standard object 204 may be associated with one or multiple environment objects 202. The association exists whether or not the relationship to the environment object 202 is stored within the standard object 204.

In some embodiments, a one-to-one relationship, one-to-many relationship, or many-to-many relationship may exist between standard objects 204 and control objects 206. That is, a particular standard object 204 may be associated with one or multiple control objects 206, and/or a particular control object 206 may be associated with one or multiple standard objects 204. A control object 206 that is “associated with” a particular standard object 204 is also “associated with” any environment object 202 that is associated with the particular standard object 204. The association exists whether or not the relationship to the environment object 202 and/or the standard object 204 is stored within the control object 206.

In some embodiments, a one-to-one relationship, one-to-many relationship, or many-to-many relationship may exist between control objects 206 and evidence objects 208. That is, a particular control object 206 may be associated with one or multiple evidence objects 208, and/or a particular evidence objects 208 may be associated with one or multiple control objects 206. An evidence object 208 that is “associated with” a particular control object 206 is also “associated with” any environment object 202 and any standard object 204 that is associated with the particular control object 206. The association exists whether or not the relationship to the environment object 202, the standard object 204, or the control object 206 is stored within the evidence object 208.

In some embodiments, the data model 200 includes one or more types of construction instructions 210-214. For example, the data model 200 may include evidence-specific construction instructions 214. The evidence-specific construction instructions 214 may include one or more parameters, arguments, pointers, references, executable code, calls, or other instructions. When a construction module (e.g. construction module 104) of a compliance server system (e.g. compliance server system 110) executes the evidence-specific construction instructions 214 for an evidence object 208, the resulting generated environment is configured such that the collected evidence data for the corresponding evidence should satisfy the corresponding control. Alternatively and/or in addition, the data model 200 may include control-specific construction instructions 212 and/or standard-specific construction instructions 210. To create a generated environment that satisfies a particular set of one or more standards represented by a set of one or more standard objects 204, the compliance server system may use any evidence-specific construction instructions 214 from evidence objects 208 associated with the set of one or more standard objects 204, control-specific construction instructions 212 from control objects 206 associated with the set of one or more standard objects 204, and/or standard-specific construction instructions 210 belonging to the set of one or more standard objects 204.

In some embodiments, the data model 200 includes one or more types of collection instructions 220-224. For example, the data model 200 may include evidence-specific collection instructions 224. The evidence-specific collection instructions 224 may include one or more parameters, arguments, pointers, references, executable code, calls, or other instructions. When an evidence collection module (e.g. evidence collection module 106) of a compliance server system executes the evidence-specific collection instructions 224 for an evidence object 208, the corresponding evidence data is collected. Alternatively and/or in addition, the data model 200 may include control-specific collection instructions 222 and/or standard-specific collection instructions 220. To audit an environment for compliance with a particular set of one or more standards represented by a set of one or more standard objects 204, the compliance server system may use any evidence-specific collection instructions 224 from evidence objects 208 associated with the set of one or more standard objects 204, control-specific collection instructions 222 from control objects 206 associated with the set of one or more standard objects 204, and/or standard-specific collection instructions 220 belonging to the set of one or more standard objects 204.

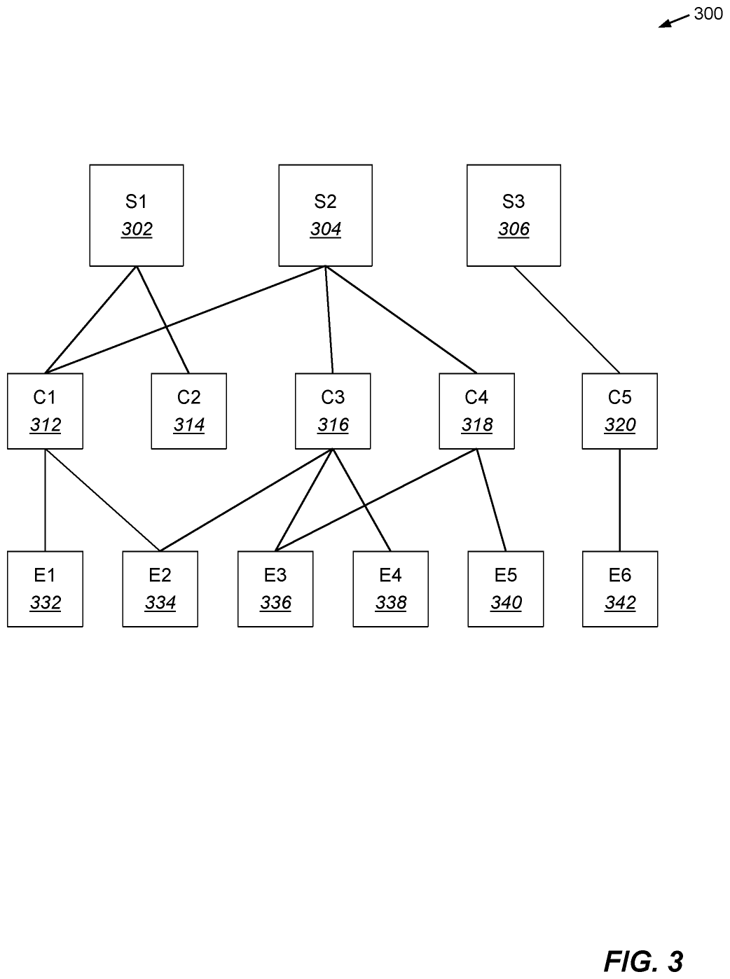

FIG. 3 illustrates relationships between standard objects, control objects, and evidence objects in a system for automated construction of compliant cloud environments in an example embodiment. In a control data set 300 stored in a controls database (e.g. controls database 108), example associations are shown between a set of one or more standard objects 302-306, a set of one or more control objects 312-320, and a set of one or more evidence objects 332-342. The same control object 312 associated with an aspect of a first standard and an aspect of a second standard may be associated with both a first standard object 302 and a second standard object 304. The same evidence object 334 may be associated a control object 312 associated with a first standard object 302 as well as a control object 316 associated with a second standard object 304.

An evidence object 336 may be associated with multiple control objects 316-318 associated with a standard object 304. Evidence-specific collection instructions (e.g. evidence-specific collection instructions 224) may be executed one time to collect the corresponding evidence data that is required for both control objects 316-318.

### Customer-Facing Portal

In some embodiments, a compliance server system (e.g. compliance server system 110) provides a customer-facing portal. For example, the compliance server system may provide a compliance system interface (e.g. compliance system interface 112) that allows a customer computer system (e.g. customer computer system 140) to interact with the compliance server system and/or assists the customer computer system in interacting with a cloud service provider system (e.g. cloud service provider system 120). A customer-facing portal may include an interface to allow a user to deploy environments including any duplicate instances. The customer-facing portal may allow a customer to monitor performance of an application deployed in the cloud environment/s, including but not limited to aspects related to compliance with one or more standards.

Evidence collection may be performed to determine a system's compliance at a particular time and/or to determine compliance over a period of time. In some embodiments, a compliance server system accesses one or more customer environments and provides compliance data to the corresponding customer. The customer may use the compliance data to manage its operations. In some embodiments, the compliance server system accesses one or more customer environments to generate a compliance report. For example, the compliance server system may generate one or more portions of a compliance report that are required for an audit of the customer for a particular standard.

### Example Processes

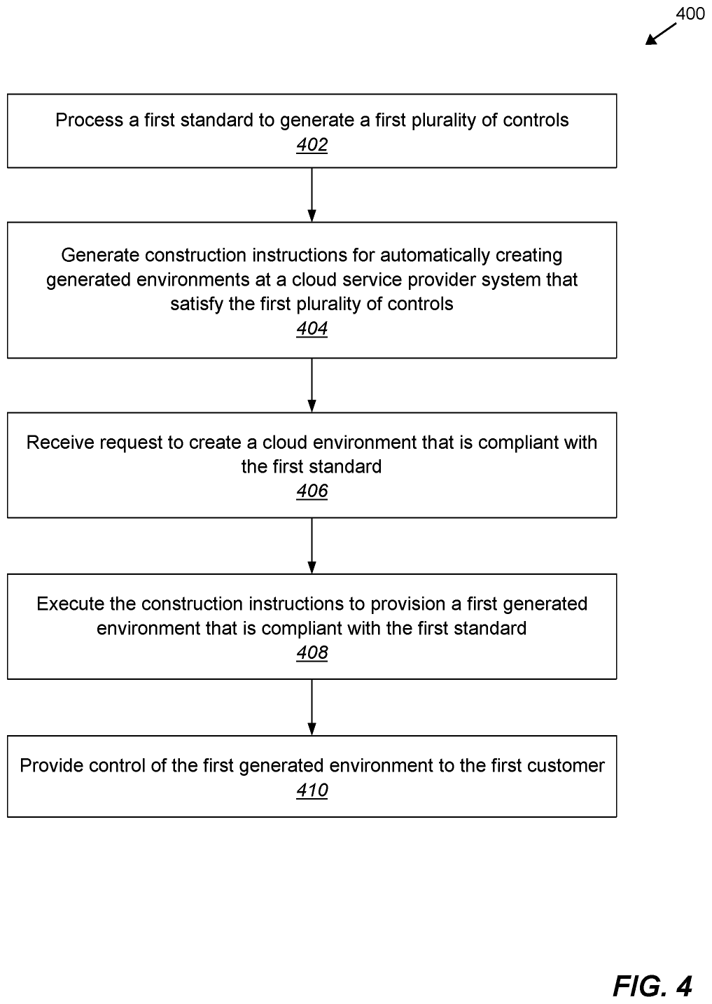

FIG. 4 is a flow diagram of a process for automated construction of compliant cloud environments in an example embodiment. Process 400 may be performed by one or more computing devices and/or processes thereof. For example, one or more blocks of process 400 may be performed by a computer system, such as but not limited to computer system 500. In one embodiment, one or more blocks of process 400 are performed by a compliance server system executing on a computing system, such as compliance server system 110. Process 400 will be described with respect to compliance server system 110, but is not limited to performance by compliance server system 110.

At block 402, the compliance server system 110 processes a first standard to generate a first plurality of controls.

At block 404, the compliance server system 110 generates construction instructions for automatically creating generated environments at a cloud service provider system that satisfy the first plurality of controls.

At block 406, the compliance server system 110 receives a request to create, at the cloud service provider system, a cloud environment that is compliant with the first standard.

At block 408, the compliance server system 110 executes the construction instructions to provision a first generated environment at the cloud service provider system that is compliant with the first standard.

At block 410, the compliance server system 110 provides control of the first generated environment to the first customer.

### Implementation Mechanisms—Hardware Overview

According to one embodiment, the techniques described herein are implemented by one or more special-purpose computing devices. The special-purpose computing devices may be hard-wired to perform one or more techniques described herein, including combinations thereof. Alternatively and/or in addition, the one or more special-purpose computing devices may include digital electronic devices such as one or more application-specific integrated circuits (ASICs) or field programmable gate arrays (FPGAs) that are persistently programmed to perform the techniques. Alternatively and/or in addition, the one or more special-purpose computing devices may include one or more general purpose hardware processors programmed to perform the techniques described herein pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices and/or any other device that incorporates hard-wired or program logic to implement the techniques.

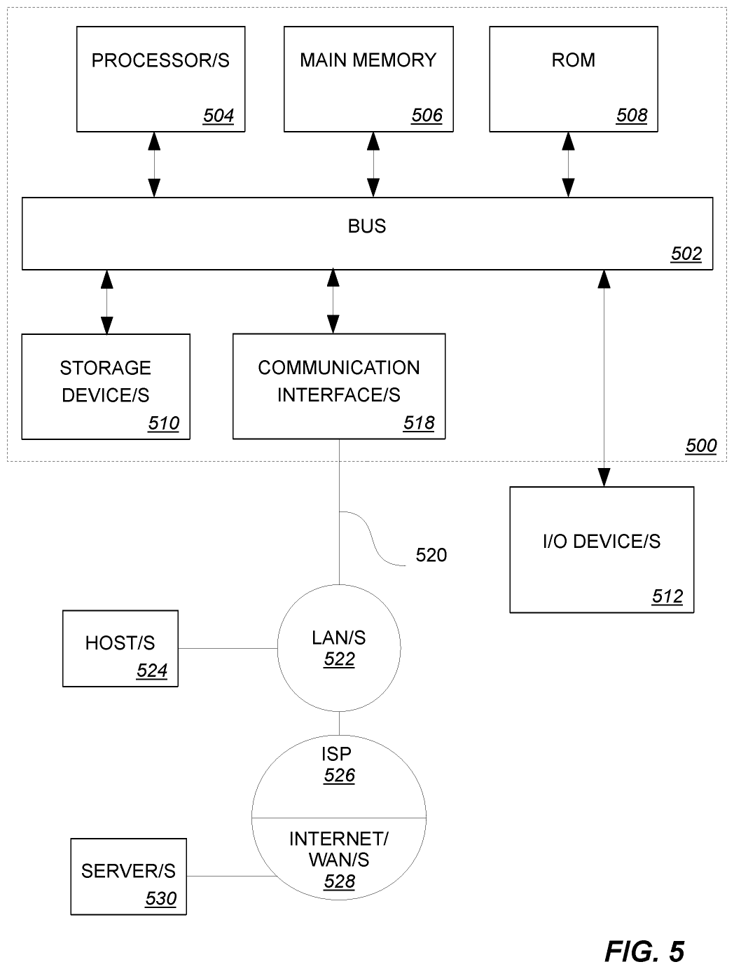

For example, FIG. 5 is a block diagram that illustrates a computer system 500 upon which an embodiment of the invention may be implemented. Computer system 500 includes a bus 502 or other communication mechanism for communicating information, and one or more hardware processors 504 coupled with bus 502 for processing information, such as basic computer instructions and data. Hardware processor/s 504 may include, for example, one or more general-purpose microprocessors, graphical processing units (GPUs), coprocessors, central processing units (CPUs), and/or other hardware processing units.

Computer system 500 also includes one or more units of main memory 506 coupled to bus 502, such as random access memory (RAM) or other dynamic storage, for storing information and instructions to be executed by processor/s 504. Main memory 506 may also be used for storing temporary variables or other intermediate information during execution of instructions to be executed by processor/s 504. Such instructions, when stored in non-transitory storage media accessible to processor/s 504, turn computer system 500 into a special-purpose machine that is customized to perform the operations specified in the instructions. In some embodiments, main memory 506 may include dynamic random-access memory (DRAM) (including but not limited to double data rate synchronous dynamic random-access memory (DDR SDRAM), thyristor random-access memory (T-RAM), zero-capacitor (Z-RAM™)) and/or non-volatile random-access memory (NVRAM).

Computer system 500 may further include one or more units of read-only memory (ROM) 508 or other static storage coupled to bus 502 for storing information and instructions for processor/s 504 that are either always static or static in normal operation but reprogrammable. For example, ROM 508 may store firmware for computer system 500. ROM 508 may include mask ROM (MROM) or other hard-wired ROM storing purely static information, programmable read-only memory (PROM), erasable programmable read-only memory (EPROM), electrically-erasable programmable read-only memory (EEPROM), another hardware memory chip or cartridge, or any other read-only memory unit.

One or more storage devices 510, such as a magnetic disk or optical disk, is provided and coupled to bus 502 for storing information and/or instructions. Storage device/s 510 may include non-volatile storage media such as, for example, read-only memory, optical disks (such as but not limited to compact discs (CDs), digital video discs (DVDs), Blu-ray discs (BDs)), magnetic disks, other magnetic media such as floppy disks and magnetic tape, solid state drives, flash memory, optical disks, one or more forms of non-volatile random access-memory (NVRAM), and/or other non-volatile storage media.

Computer system 500 may be coupled via bus 502 to one or more input/output (I/O) devices 512. For example, I/O device/s 512 may include one or more displays for displaying information to a computer user, such as a cathode ray tube (CRT) display, a Liquid Crystal Display (LCD) display, a Light-Emitting Diode (LED) display, a projector, and/or any other type of display.

I/O device/s 512 may also include one or more input devices, such as an alphanumeric keyboard and/or any other key pad device. The one or more input devices may also include one or more cursor control devices, such as a mouse, a trackball, a touch input device, or cursor direction keys for communicating direction information and command selections to processor 504 and for controlling cursor movement on another I/O device (e.g. a display). This input device typically has at degrees of freedom in two or more axes, (e.g. a first axis x, a second axis y, and optionally one or more additional axes z . . . ), that allows the device to specify positions in a plane. In some embodiments, the one or more I/O device/s 512 may include a device with combined I/O functionality, such as a touch-enabled display.

Other I/O device/s 512 may include a fingerprint reader, a scanner, an infrared (IR) device, an imaging device such as a camera or video recording device, a microphone, a speaker, an ambient light sensor, a pressure sensor, an accelerometer, a gyroscope, a magnetometer, another motion sensor, or any other device that can communicate signals, commands, and/or other information with processor/s 504 over bus 502.

Computer system 500 may implement the techniques described herein using customized hard-wired logic, one or more ASICs or FPGAs, firmware or program logic which, in combination with the computer system causes or programs, causes computer system 500 to be a special-purpose machine. According to one embodiment, the techniques herein are performed by computer system 500 in response to processor/s 504 executing one or more sequences of one or more instructions contained in main memory 506. Such instructions may be read into main memory 506 from another storage medium, such as one or more storage device/s 510. Execution of the sequences of instructions contained in main memory 506 causes processor/s 504 to perform the process steps described herein. In alternative embodiments, hard-wired circuitry may be used in place of or in combination with software instructions.

Computer system 500 also includes one or more communication interfaces 518 coupled to bus 502. Communication interface/s 518 provide two-way data communication over one or more physical or wireless network links 520 that are connected to a local network 522 and/or a wide area network (WAN), such as the Internet. For example, communication interface/s 518 may include an integrated services digital network (ISDN) card, cable modem, satellite modem, or a modem to provide a data communication connection to a corresponding type of telephone line. Alternatively and/or in addition, communication interface/s 518 may include one or more of: a local area network (LAN) device that provides a data communication connection to a compatible local network 522; a wireless local area network (WLAN) device that sends and receives wireless signals (such as electrical signals, electromagnetic signals, optical signals or other wireless signals representing various types of information) to a compatible LAN; a wireless wide area network (WWAN) device that sends and receives such signals over a cellular network access a wide area network (WAN, such as the Internet 528); and other networking devices that establish a communication channel between computer system 500 and one or more LANs 522 and/or WANs.

Network link/s 520 typically provides data communication through one or more networks to other data devices. For example, network link/s 520 may provide a connection through one or more local area networks 522 (LANs) to one or more host computers 524 or to data equipment operated by an Internet Service Provider (ISP) 526. ISP 526 in turn provides connectivity to one or more wide area networks 528, such as the Internet. LAN/s 522 and WAN/s 528 both use electrical, electromagnetic or optical signals that carry digital data streams. The signals through the various networks and the signals on network link/s 520 and through communication interface/s 518 are example forms of transmission media, or transitory media.

The term “storage media” as used herein refers to any non-transitory media that stores data and/or instructions that cause a machine to operate in a specific fashion. Such storage media may include volatile and/or non-volatile media. Storage media is distinct from but may be used in conjunction with transmission media. Transmission media participates in transferring information between storage media. For example, transmission media includes coaxial cables, copper wire and fiber optics, including traces and/or other physical electrically conductive components that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its main memory 506 and send the instructions over a telecommunications line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 can send messages and receive data, including program code, through the network(s), network link 520 and communication interface 518. In the Internet example, one or more servers 530 might transmit signals corresponding to data or instructions requested for an application program executed by the computer system 500 through the Internet 528, ISP 526, local network 522 and a communication interface 518. The received signals may include instructions and/or information for execution and/or processing by processor/s 504. Processor/s 504 may execute and/or process the instructions and/or information upon receiving the signals by accessing main memory 506, or at a later time by storing them and then accessing them from storage device/s 510.

### OTHER ASPECTS OF DISCLOSURE

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
processing a first standard to generate a first plurality of controls;
generating construction instructions for automatically creating generated environments at a cloud service provider system that satisfy the first plurality of controls;
receiving a request to create, at the cloud service provider system, a cloud environment that is compliant with the first standard for a first customer;
executing the construction instructions to provision a first generated environment at the cloud service provider system that is compliant with the first standard;
providing control of the first generated environment to the first customer;
wherein the method is performed on a computer system comprising one or more processors.

2. The method of claim 1, further comprising:
receiving a request to create, at the cloud service provider system, a second cloud environment that is compliant with the first standard for a second customer;
executing the construction instructions to provision a second generated environment at the cloud service provider system that is compliant with the first standard;
providing control of the second generated environment to the second customer.

3. The method of claim 1, further comprising:
generating second construction instructions for automatically creating generated environments at a second cloud service provider system that satisfy the first plurality of controls;
receiving a request to create, at the second cloud service provider system, a third cloud environment that is compliant with the first standard;
executing the second construction instructions to provision a third generated environment at the second cloud service provider system that is compliant with the first standard.

4. The method of claim 1, further comprising:
associating at least one control of the first plurality of controls with one or more evidence types;
generating evidence-specific construction instructions for the one or more evidence types;
wherein executing the construction instructions includes executing any evidence-specific construction instructions associated with evidence types associated with the first plurality of controls.

5. The method of claim 4, further comprising:
generating evidence-specific collection instructions for collecting evidence data of the one or more evidence types;
wherein, when executed, the evidence-specific collection instructions obtain, from the cloud service provider system, evidence data of the one or more evidence types that is expected to be compliant with the first standard based on execution of the evidence-specific construction instructions.

6. The method of claim 1, further comprising:
generating collection instructions for collecting evidence data from generated environments about the first plurality of controls;
receiving a request to check the first generated environment for compliance with the first standard;
executing the collection instructions to collect first evidence data from the first generated environment;
verifying that the first evidence data satisfies the first plurality of controls associated with the first standard.

7. The method of claim 1, further comprising:
maintaining a data model comprising data for a plurality of standards that includes the first standard;
wherein processing the first standard includes applying the data model to the first standard;
wherein the data model includes:
a plurality of standards,
a plurality of controls each associated with one or more of the plurality of standards, and
a plurality of evidence types each associated with one or more of the plurality of controls.

8. The method of claim 7, wherein the data model further includes:
a plurality of evidence-specific construction instructions associated with the one or more evidence types, and
a plurality of evidence-specific collection instructions associated with the one or more evidence types.

9. The method of claim 1, further comprising:
processing a plurality of standards that includes the first standard to generate a plurality of controls that includes the first plurality of controls.

10. The method of claim 9, further comprising:
receiving a request to create, at the cloud provider system, a third cloud environment that is compliant with two or more selected standards selected from the plurality of standards;
selecting a set of controls associated with the two or more selected standards from the plurality of controls;
selecting a set of construction instructions associated with the set of controls;
executing the set of construction instructions associated with the set of controls to provision a third generated environment at the cloud provider system that is compliant with the two or more selected standards.

11. A computer system comprising:
one or more hardware processors;
at least one memory coupled to the one or more hardware processors and storing one or more instructions which, when executed by the one or more hardware processors, cause the one or more hardware processors to:
process a first standard to generate a first plurality of controls;
generate construction instructions for automatically creating generated environments at a cloud service provider system that satisfy the first plurality of controls;
receive a request to create, at the cloud service provider system, a cloud environment that is compliant with the first standard for a first customer;
execute the construction instructions to provision a first generated environment at the cloud service provider system that is compliant with the first standard;
provide control of the first generated environment to the first customer.

12. The computer system of claim 11, wherein the one or more instructions, when executed by the one or more hardware processors, cause the one or more hardware processors to:
receive a request to create, at the cloud service provider system, a second cloud environment that is compliant with the first standard for a second customer;
execute the construction instructions to provision a second generated environment at the cloud service provider system that is compliant with the first standard;
provide control of the second generated environment to the second customer.

13. The computer system of claim 11, wherein the one or more instructions, when executed by the one or more hardware processors, cause the one or more hardware processors to:
generate second construction instructions for automatically creating generated environments at a second cloud service provider system that satisfy the first plurality of controls;
receive a request to create, at the second cloud service provider system, a third cloud environment that is compliant with the first standard;
execute the second construction instructions to provision a third generated environment at the second cloud service provider system that is compliant with the first standard.

14. The computer system of claim 11, wherein the one or more instructions, when executed by the one or more hardware processors, cause the one or more hardware processors to:
associate at least one control of the first plurality of controls with one or more evidence types;
generate evidence-specific construction instructions for the one or more evidence types;
wherein executing the construction instructions includes executing any evidence-specific construction instructions associated with evidence types associated with the first plurality of controls.

15. The computer system of claim 14, wherein the one or more instructions, when executed by the one or more hardware processors, cause the one or more hardware processors to:
generate evidence-specific collection instructions for collecting evidence data of the one or more evidence types;
wherein, when executed, the evidence-specific collection instructions obtain, from the cloud service provider system, evidence data of the one or more evidence types that is expected to be compliant with the first standard based on execution of the evidence-specific construction instructions.

16. The computer system of claim 11, wherein the one or more instructions, when executed by the one or more hardware processors, cause the one or more hardware processors to:
generate collection instructions for collecting evidence data from generated environments about the first plurality of controls;
receive a request to check the first generated environment for compliance with the first standard;
execute the collection instructions to collect first evidence data from the first generated environment;
verify that the first evidence data satisfies the first plurality of controls associated with the first standard.

17. The computer system of claim 11, wherein the one or more instructions, when executed by the one or more hardware processors, cause the one or more hardware processors to:
maintain a data model comprising data for a plurality of standards that includes the first standard;
wherein processing the first standard includes applying the data model to the first standard;
wherein the data model includes:
a plurality of standards,
a plurality of controls each associated with one or more of the plurality of standards, and
a plurality of evidence types each associated with one or more of the plurality of controls.

18. The computer system of claim 17, wherein the data model further includes:
a plurality of evidence-specific construction instructions associated with the one or more evidence types, and
a plurality of evidence-specific collection instructions associated with the one or more evidence types.

19. The computer system of claim 11, wherein the one or more instructions, when executed by the one or more hardware processors, cause the one or more hardware processors to:
process a plurality of standards that includes the first standard to generate a plurality of controls that includes the first plurality of controls.

20. The computer system of claim 19, wherein the one or more instructions, when executed by the one or more hardware processors, cause the one or more hardware processors to:
receive a request to create, at the cloud provider system, a third cloud environment that is compliant with two or more selected standards selected from the plurality of standards;
select a set of controls associated with the two or more selected standards from the plurality of controls;
select a set of construction instructions associated with the set of controls;
execute the set of construction instructions associated with the set of controls to provision a third generated environment at the cloud provider system that is compliant with the two or more selected standards.
